(19) United States
(12) Patent Application Publication
(10) Pub. No.: US 2011/0212640 A1
(43) Pub. Date: Sep. 1, 2011

(54) ELECTRIC, WATER VAPOR DIFFUSION RESISTANT PIN-AND-SOCKET CONNECTOR

(75) Inventors: Gerrit Lange, Freiburg (DE); Karl-Friedrich Haarburger, Freiburg (DE)

(73) Assignee: Concentrix Solar GMBH

(21) Appl. No.: 12/995,454

(22) PCT Filed: May 28, 2009
(86) PCT No.: PCT/EP09/03830

§ 371 Date: May 16, 2011

(30) Foreign Application Priority Data
May 30, 2008 (DE) 10 2008 025 955.1

(51) Int. Cl. H01R 13/52

(52) U.S. Cl. 439/271

(57) ABSTRACT

A nonconductive plate that is plated-through with an electric pin-and-socket connector in a water vapor diffusion resistant manner as well as its use as back side or side wall of a photovoltaic module is provided. The electric pin-and-socket connector includes a push-through element and a pressing element as well as a sealing element located on the pressing element and made of a material with a low water vapor diffusion rate. By the engagement of the push-through element into a retention element on a second side of the nonconducting plate, the sealing element is pressed against the first side of the plate by the pressing element and thus seals the bore in the plate in a water vapor diffusion resistant manner.

### CROSS REFERENCE OF PRIOR APPLICATION

The present application claims priority from International Patent Application No. PCT/EP2009/003830 filed May 28, 2009, and from German Patent No. 10 2008 025 955.1 filed May 30, 2008 the disclosures of which are incorporated herein by reference in their entireties.

### TECHNICAL FIELD OF THE DISCLOSURE

The present disclosure relates to the provision of a nonconductive plate that is plated-through with an electric pin-and-socket connector in a water vapor diffusion resistant manner, as well as its use as a back side or a side wall of a photovoltaic module.

### BACKGROUND

In conventional photovoltaic modules, the individual solar cells are laminated in a glass and plastics compound, and thus are already sufficiently protected from water vapor. Bonding is then effected via small connecting strands leading through the back side of the module that are bonded within a connecting box, which, however, does not offer protection from water vapor diffusion.

Since the development of photovoltaic modules that are designed such that a plurality of unprotected solar cells are located in an evacuated hollow space, various solutions for water vapor diffusion resistant electric bonding have been suggested. Such a water vapor diffusion barrier is necessary as otherwise condensation of the water vapor, and thus optical and electric loss in performance would occur in use due to temperature differences. A water vapor diffusion resistant electric bonding is provided to conduct the current generated by the solar cells inside the evacuated hollow space to the outside without water vapor diffusion into the hollow space or into the module taking place, which would result in the module losing performance.

A common solution, though one that is not automated, is to manually solder the connecting strand leads through bores in the module back wall to connecting cables and subsequently seal the bore and the joints with a butyl compound. However, this is not a true pin-and-socket connection.

The pin-and-socket connectors known from vacuum technology and cryogenics which are embodied as contact bodies coated with plastics, are not suited for being employed in photovoltaics as the characteristic for these is a minimum leak rate and not a minimum water vapor diffusion rate over a long period (up to 20 years or more, comparable to the service life of insulating glass units) as in photovoltaic modules. In contrast to photovoltaic modules, in vacuum technology and cryogenics, permanently operating pumps are employed that take care of maintaining the vacuum and suck off possibly diffused water vapor so that, with respect to long-time diffusion processes, lower demands are placed on the pin-and-socket connection.

Thus, for bonding photovoltaic modules, at present either conventional connecting boxes with high-quality agglutination but without a water vapor diffusion barrier or complicated soldering methods with subsequent sealing are employed.

### SUMMARY

In one embodiment, the presently disclosed is an apparatus for providing water vapor diffusion resistance in a photovoltaic module, which may include a nonconducting plate having a first side and a second side; an electric pin-and-socket connector plate through the nonconducting plate in a vapor diffusion resistant manner and comprising a pressing element and a push-through element; and a first sealing element arranged in a compressed manner between the pressing element and the first side and comprising a water vapor diffusion stable material.

The push-through element may be configured to be pushed from the first side partially through a bore in the nonconducting plate at an angle.

In some embodiments, the push-through element may be configured to engage with a retention element attached to the second side in a positive or a non-positive fit. The push-through element and the retention element may be associated for securing by bolting mechanisms, undercut mechanisms, or snap lock mechanisms. The retention element may at least partially enclose a part of the push-through element pushed through the bore. The retention element may be made of a conductive material, and it may be glued to the second side.

In further embodiments, a side of the pressing element facing the first side may be substantially planar and arranged with respect to the push-through element so as to be vertically offset or stepped. The electric pin-and-socket connector may be formed integrally and be made of a metal, including brass, bronze, copper, or a mixture thereof.

In still further embodiments, an annular protective element may be arranged between the first side and the pressing element, and the protective element is configured for protecting the plate from metal elements and for protecting the first sealing element from external influences. The protective element may be a plastic ring made of thermoplastics. It may be configured to completely surround the first sealing element. The first sealing element may have a water vapor diffusion rate of less than about 0.5 g/(m²d), or, it may have a vapor diffusion rate of about 0.25 g/(m²d) or less. The first sealing element may include an O-ring or a gasket. The first sealing element may be made of an ethylene propylene diene rubber material or a butyl rubber material, or a mixture thereof.

In additional embodiments, the pressing element may include at least one bore, and between the first side and the pressing element, a second sealing element is arranged, the second sealing element being injectable via the at least one bore of the pressing element into a space between the pressing element and the first side. The second sealing element have a water vapor diffusion rate of less than about 0.1 g/(m²d). The second sealing element may be made of butyl rubber, polyisobutylene, a molecular sieve, or a drying agent, or a combination thereof.

In other embodiments, the pin-and-socket connector may be at least partially covered with an insulating material. The nonconducting plate may be a glass plate. Additionally, the apparatus may be configured as a side wall of the photovoltaic module, and a plurality of solar cells located inside the photovoltaic module are interconnected or bonded with the retention element. The plurality of solar cells may be interconnected via bonding or are bonded with the retention element. Further. the solar cells may be glued to the second side.

While multiple embodiments are disclosed, still other embodiments of the disclosure will become apparent to those skilled in the art from the following detailed description which shows and describes illustrative embodiments of the disclosure. As will be realized, the embodiments described herein are capable of modification in various aspects, all without departing from the sprit and scope of the disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying figures in which:

FIG. 1 shows a cross-section of an example embodiment of a nonconducting plate that is plated-through with an electric pin-and-socket connector in a water vapor diffusion resistant manner employed in a photovoltaic module in accordance with the present disclosure; and

FIG. 2 shows a cross-section of another example embodiment of a nonconducting plate that is plated-through with an electric pin-and-socket connector in a water vapor diffusion resistant manner employed in a photovoltaic module in accordance with the present disclosure.

The figures provided herein are intended to be illustrative and broadly representative of certain embodiments of the present disclosure and as such the should not be understood as requiring any scalar relationship of or between the various components depicted therein.

### DETAILED DESCRIPTION

The water vapor diffusion resistant throughplating of the nonconducting plate according to the present disclosure may be accomplished by an electrically conductive pin-and-socket connector, which may generally be an protrusion received into a receptacle, a retention element, which may be a fastening element, and at least one sealing element. The electric pin-and-socket connector may include a pressing element and a push-through element perpendicular thereto, wherein the pressing element may be configured as, for example, as round web which surrounds a rod-like push-through element at its lower end, or other appropriate configuration. According to the present disclosure, the pin-and-socket connector may be partially pushed through a bore with the push-through element from a first side of the nonconducting plate. The upper part of the push-through element projecting from the nonconducting plate on the second side may grip into a retention element on the second side of the nonconducting plate with a positive and/or non-positive fit. At least one sealing element, located between the first side of the nonconducting plate and the pressing element and surrounding the push-through element, may be compressed. By the compression, the sealing element may flow into the microstructure of the plate and the pressing element and seals the bore with the introduced electric pin-and-socket connector in a water vapor diffusion resistant manner.

Thus, a particular aspect of the present disclosure may be to achieve a sealing effect between the nonconducting plate and the massive, integrally formed pin-and-socket connector.

The non-positive and/or positive engagement of the upper part of the push-through element can be effected by various mechanisms. For example, a spring force connection, a crimp connection, a screw connection, an insulation displacement connection, and/or a soldered connection offer themselves as advantageous connecting mechanisms. For example, the retention element can comprise an undercut, and the push-through element can comprise a counterpart that engages the undercut with a positive and/or non-positive fit. A connection between the push-through element and the retention element via a snap lock would e.g. also be conceivable. Preferably, a nut into which a screw thread is screwed at the upper part of the push-through element may be used as retention element. Bolting the electric pin-and-socket connector with the nut, for example via an M4 thread, may be a preferable configuration for retention the pin-and-socket connector to the plate, making sure that the sealing element is compressed between the pressing element and the plate, thereby providing a seal.

Preferably, the retention element, which may preferably be a die or a cap nut, may cover the complete upper part of the push-through element that projects from the nonconducting plate on the second side. Here, the retention element may include a conductive material. In particular, the retention element may include a metal. As an alternative, the retention element can include electrically conductive plastics and/or semiconductor materials.

Where a retention element which in contrast does not completely cover said upper part of the push-through element is provided, for example a conventional screw nut, suited nonconducting materials can also be used, where an additional contact element may be provided. Therefore, electric bonding is either effected via a conductive retention element or via an additional contact element.

The retention element may preferably be firmly fixed, for example glued, to the second side of the nonconducting plate, the agglutination not having to be water vapor diffusion resistant.

The pin-and-socket connector may include a conductive material, for example metal. Preferably, brass, bronze, and/or copper, or a brass, bronze, and/or copper containing material, may be employed. As an alternative, electrically conductive plastics and/or semiconductor materials can be employed. The pin-and-socket connector thus may only be formed integrally.

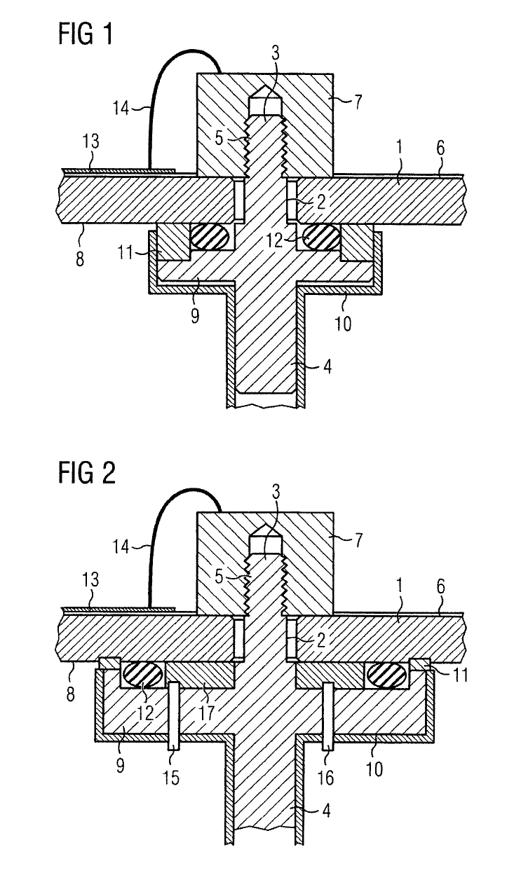

The side of the pressing element facing the first side of the plate may be preferably embodied to be substantially planar. Furthermore, the pin-and-socket connector can be designed such that the side of the pressing element facing the first side of the plate takes the shape of plane disks or plates and/or frame elements of different dimensions that are arranged around the push-through element so as to be vertically offset and/or stepped, so that differently dimensioned sealing elements can be arranged thereupon. Examples of this can be taken from FIGS. 1 and 2.

Preferably, the nonconducting plate according to the present disclosure may include a protective element, which may be a stopper element, between the first side of the plate and the pressing element. The protective element on the one may hand serves as mechanical protection of the glass from the metal element and of the sealing element or elements from external influences. On the other hand, it may serve to avoid excessive, irregular, and/or incorrect deformations of the at least one sealing element. A plastic ring which may preferably include commercially available thermoplastics can be used as protective element. The diameter of this plastic ring may be preferably large enough for the sealing element or elements to be situated within its inner diameter. Therefore, the at least one sealing element may be completely surrounded by the plastic ring. In addition, further protective elements with smaller diameters can be possibly attached.

In particular O-rings may be provided as sealing elements as these surround the push-through element uniformly. This may allow for the sealing element to be uniformly compressed, so that water vapor cannot diffuse at one single point. However, gaskets or the like can also be used. The sealing element may have a low water vapor diffusion rate, preferably of less than about 0.5 g/(m²d), in particular less than about 0.3 g/(m²d), in particular about 0.25 g/(m²d) or less. Therefore, for example EPDM materials (ethylene propylene diene rubber) or butyls, e.g. isobutene isoprene rubber (IIR) or chlorine isobutene isoprene rubber (CIIR), or EPDM-based or butyl-based materials may be provided as materials for the sealing element.

After the pin-and-socket connector according to the present disclosure has been fastened to the nonconducting plate, an additional sealing material can be preferably inserted between the pressing element and the nonconducting plate. For this, the pressing element may either include a bore or at least one injection bore and at least one air balance bore. A sealing element possibly located on the pressing element may be arranged at a certain distance to the push-through element, such that the plate, the pressing element and the sealing element generate a hollow space. In the hollow space between the plate and the pressing element, an additional sealing material may be injected through the one bore, where it may be ensured that the air present in the hollow space can escape through the same bore. As an alternative, an additional sealing material which uniformly fills the hollow space can be injected through the injection bore in a dispensing process. The air initially present in the hollow space may thus escape via the air balance bore. Preferably, the additional sealing material may have a water vapor diffusion rate of about 0.1 g/(m²d) or less. Butyl rubber or a material on the basis of polyisobutylene, or a mixture thereof, may be provided as an additional sealing material. As an alternative, a thermoplastic spacer, a molecular sieve, and/or a drying agent, or a mixture of at least one of these mentioned materials, can be used as additional sealing means. It is appreciated that butyl rubber and/or the thermoplastic spacer (Thermo Plastic Spacer, TPS) on the basis of polyisobutylene may be employed in insulating glass technology and ensure a diffusion barrier with a diffusion rate of approximately 0.1 g/(m²d) or less over a period of approximately 20 years and more.

As throughplating of the plate is effected by means of an electric pin-and-socket connector, it may be advantageous to insulate the lower part of the pin-and-socket connector, that means in particular the part of the pressing element facing away from the first side of the nonconducting plate, a plastic coating serving, for example, as insulation.

Due to the simple form of the electric pin-and-socket connector for throughplating a nonconducting plate, automated manufacture is possible. Moreover, the assembly of the plug through the nonconducting plate can be automated.

According to the present disclosure, the plated-through, nonconducting plate can also include several throughplatings in the form of bores which are sealed by electric pin-and-socket connectors with sealing elements, which are in turn fastened to the plate by retention elements. For example, a glass plate may be provided as a nonconducting plate.

Plated-through, nonconducting plates, in particular plated-through glass plates, as disclosed herein may be preferably employed in insulation glass technology and photovoltaics.

The disclosed plated-through plate may preferably serve as back side or any side wall of an evacuated photovoltaic module or a photovoltaic module filled with a dry purging gas or noble gas. On the plated-through, nonconducting plate, a plurality of solar cells may be advantageously arranged. The solar cells may be interconnected and/or electrically bonded with the electric pin-and-socket connector via the retention element or the additional contact element, so that the generated current can flow off via the throughplatings. Preferably, the solar cells may be interconnected by bonding or soldering and/or electrically bonded with the retention element or the additional bonding element.

The retention element as well as the solar cells may be advantageously fastened to the back side of the module, preferably on the second side of the plated-through, nonconducting plate or glass plate, respectively. Retention may be advantageously effected by gluing.

Furthermore, the disclosed plated-through, nonconducting plate can be employed in vacuum technology and cryogenics as well as in insulating glass technology.

Hereinafter, some examples of the application of the disclosed nonconducting plate plated-through with an electric pin-and-socket connector in photovoltaic modules are given. The examples only serve to illustrate particular embodiments of the disclosure and are not meant to be restrictive in any way.

With explicit reference now to FIG. 1, therein is shown a cross-section through a detail of a nonconducting plate plated-through with an electric pin-and-socket connector representing a bottom or back side, respectively, of a photovoltaic module. The nonconducting plate 1, in particular a glass plate, has a bore 2. A push-through element 3 of an electric pin-and-socket connector 4 is inserted through the bore 2, so that its upper part, which includes a screw thread 5, projects from the second side 6 of the glass plate 1. The electric pin-and-socket connector 4 is fastened by means of a retention element 7, in particular a die nut made of brass, which is glued to the second side 6 of the glass plate 1 so that the pressing element 9 is pulled against the first side 8 of the glass plate 1. On the first side 8 of the glass plate 1, one can see the pressing element 9 which is partially covered by a plastic coating 10. Between the pressing element 9 and the first side 8 of the glass plate 1, a protective element 11, in particular a plastic ring, which serves as protection of the glass plate 1 from the pressing element 9 of brass, and a sealing element 12, in particular an O-ring of an EPDM material, are located. The O-ring 12 is compressed to such an extent that it flows into the microstructure of the glass and brass and seals the region between the bore 2 and the pin-and-socket connector 4 in a water vapor diffusion resistant manner, so that no water vapor can diffuse into the evacuated hollow space of the module. Furthermore, a solar cell 13 is mounted in the interior of the module on the second side 6 of the glass plate 1 the solar cell being electrically bonded with the nut 7 by means of bonding technology 14.

With explicit reference now to FIG. 2 again shown therein is a cross-section through a detail of a nonconducting plate plated-through with an electric pin-and-socket connector employed as bottom side of a photovoltaic module. As already shown in FIG. 1, a pin-and-socket connector 4 and an O-ring 12 are provided, the pin-and-socket connector being fastened to the glass plate 1 with the nut 7. In contrast to FIG. 1, the sealing effect here is not caused by the O-ring 12, which in this example only serves as splash protection, but mainly by an additional sealing material 17, for example TPS and/or butyl. Here, a butyl cord 17 is injected through an injection bore 15 into a hollow space which is generated by the glass plate 1 the pressing element 4 and the O-ring 12, after the pressing element 9 has been pulled towards the first side 8 of the glass plate 1. The air balance bore 16 ensures that the air present in the hollow space and possibly excessive butyl material can escape during the injection process.

As used herein the terms “front,” “back,” and/or other terms indicative of direction are used herein for convenience and to depict relational positions and/or directions between the parts of the embodiments. It will be appreciated that certain embodiments, or portions thereof, can also be oriented in other positions.

As used herein, the terms “front,” “back,” and/or other terms indicative of direction are used herein for convenience and to depict relational positions and/or directions between the parts of the embodiments. It will be appreciated that certain embodiments, or portions thereof, can also be oriented in other positions. In addition, the term “about” should generally be understood to refer to both the corresponding number and a range of numbers. In addition, all numerical ranges herein should be understood to include each whole integer within the range. While an illustrative embodiment of the invention has been disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1-24. (canceled)

25. An apparatus for providing water vapor diffusion resistance in a photovoltaic module comprising:
a nonconducting plate having a first side and a second side;
an electric pin-and-socket connector plating-through the nonconducting plate in a vapor diffusion resistant manner and comprising a pressing element and a push-through element; and
a first sealing element arranged in a compressed manner between the pressing element and the first side and comprising a water vapor diffusion stable material,
wherein the push-through element is configured to be pushed from the first side partially through a bore in the nonconducting plate at an angle.

26. The apparatus of claim 25 wherein the push-through element is configured to engage with a retention element attached to the second side in a positive or a non-positive fit.

27. The apparatus of claim 26, wherein the push-through element and the retention element are associated for securing by bolting mechanisms, undercut mechanisms, or snap lock mechanisms.

28. The apparatus of claim 25, wherein the retention element at least partially encloses a part of the push-through element pushed through the bore.

29. The apparatus of claim 25, wherein the retention element comprises a conductive material.

30. The apparatus of claim 25, wherein the retention element is glued to the second side.

31. The apparatus of claim 25, wherein a side of the pressing element facing the first side is substantially planar and arranged with respect to the push-through element so as to be vertically offset or stepped.

32. The apparatus of claim 25, wherein the electric pin-and-socket connector is formed integrally and comprises a metal selected from the group consisting of brass, bronze, copper, and a mixture thereof.

33. The apparatus of claim 25, further comprising an annular protective element arranged between the first side and the pressing element, wherein the protective element is configured for protecting the plate from metal elements and for protecting the first sealing element from external influences.

34. The apparatus of claim 33, wherein the protective element comprises a plastic ring made of thermoplastics.

35. The apparatus of claim 33, wherein the protective element is configured to completely surround the first sealing element.

36. The apparatus of claim 25, wherein the first sealing element has a water vapor diffusion rate of less than about 0.5 g/(m²d).

37. The apparatus of claim 40, wherein the first sealing element has a water vapor diffusion rate of about 0.25 g/(m²d) or less.

38. The apparatus of claim 25, wherein the first sealing element comprises an O-ring or a gasket.

39. The apparatus of claim 25, wherein the first sealing element comprises an ethylene propylene diene rubber material or a butyl rubber material, or a mixture thereof

40. The apparatus of claim 25, wherein the pressing element comprises at least one bore, and wherein between the first side and the pressing element, a second sealing element is arranged, the second sealing element being injectable via the at least one bore of the pressing element into a space between the pressing element and the first side.

41. The apparatus of claim 40, wherein the second sealing element has a water vapor diffusion rate of less than about 0.1 g/(m²d).

42. The apparatus of claim 40, wherein the second sealing element comprises butyl rubber, polyisobutylene, a molecular sieve, or a drying agent, or a combination thereof.

43. The apparatus of claim 25, wherein the pin-and-socket connector is at least partially covered with an insulating material.

44. The apparatus of claim 25, wherein the nonconducting plate comprises a glass plate.

45. The apparatus of claim 25, wherein the apparatus is configured as a side wall of the photovoltaic module, wherein a plurality of solar cells located inside the photovoltaic module are interconnected or bonded with the retention element.

46. The apparatus of claim 45, wherein the plurality of solar cells are interconnected via bonding or are bonded with the retention element.

47. The apparatus of claim 45, wherein the solar cells are glued to the second side.

48. The apparatus of claim 25, further comprising a second sealing element arranged between the first side and the pressing element, and an annular protective element arranged between the first side and the pressing element, wherein the protective element is configured for protecting the plate from metal elements and for protecting the first sealing element from external influences.
